(19) United States
(12) Patent Application Publication
(10) Pub. No.: US 2008/0111348 A1
(43) Pub. Date: May 15, 2008

(54) Covertible trailer and hitch mountable platform

(76) Inventor: Michael S. Lawson, Clinton, MO (US)

Correspondence Address: SHUGHART THOMSON & KILROY, PC, 120 WEST 12TH STREET, KANSAS CITY, MO, 64105, US

(21) Appl. No.: 11/595,191

(22) Filed: Nov. 9, 2006

(51) Int. Cl. B62D 63/08; B60D 1/06; B60R 9/06

(52) U.S. Cl. 280/511; 280/504

(57) ABSTRACT

A convertible trailer and hitch-mountable platform apparatus has a platform assembly with removable wheel and tow bar assemblies. The platform is equipped with structure for mounting the disengaged tow bar in a transverse orientation to provide structural support when mounted on the receiver hitch of a vehicle for use as a utility platform. The tow bar includes a longitudinal tongue which is received in a transversely centered longitudinal member for a trailer configuration or a longitudinally centered cross member for a platform configuration. One end of the transversely assembled tow bar is mountable on the vehicle hitch receiver for supporting the utility platform and wheels in a generally horizontal position. The platform also includes structure for stowing the wheel assemblies. Each wheel assembly includes an axle assembly that is positionable to shift the wheels 90° upwardly and rearwardly for lowering the trailer deck for towing use behind a lawn tractor, mower or the like.

### CROSS-REFERENCE TO RELATED APPLICATION

This application claims priority under 35 U.S.C. 119(e) and 37 C.F.R. 1.78(a)(4) based upon copending U.S. Provisional Application, Ser. No. 60/73,376 for CONVERTIBLE TRAILER AND HITCH MOUNTED PLATFORM, filed Nov. 11, 2005. The subject matter of the provisional application is expressly incorporated herein by reference.

### BACKGROUND OF THE INVENTION

The present invention is broadly concerned with a load transporting trailer that can be easily converted into a utility carrier for mounting on the hitch socket of a vehicle. More particularly, it is concerned with an improved height-adjustable trailer having stowable wheels and a repositionable tongue for reconfiguring the trailer as a utility platform that can be supported by a vehicle hitch socket.

Conventional towable trailers are designed for pulling behind a vehicle such as a pickup truck, sport utility vehicle or the like to transport loads over public roads and highways. A pair of ground engaging wheels is mounted on an axle positioned below a platform or bed, and a tow bar or tongue extends forwardly beyond the platform for coupling with a hitch mechanism such as a ball or pin type hitch. Such trailers are constructed with the platform positioned well above the axles so that there is sufficient clearance between the lower surface of the towing platform and the roadway to permit navigation of dips and potholes in the roadway at highway speeds. Consequently, such trailers are not well-suited for towing by smaller vehicles such as lawn tractors, all-terrain vehicles (ATVs), and the like which are constructed with hitch connections that are relatively low to the ground.

While conventional utility platforms are available for mounting on the hitch socket of a vehicle, such platforms are not convertible into trailer units, since they lack both the wheels and tow bar which are necessary elements of towable trailers. In addition, neither conventional trailers nor utility platforms are constructed to include structure for stowing the wheels and converting the tow bar into a platform support element.

Small, lightweight trailers are well-suited for use in transporting equipment employed in various recreational activities such as camping, cycling and hunting. Hunters in particular often transport an all terrain vehicle (ATV) to the hunt site by loading the ATV onto the bed of a truck. The truck may also be equipped with a hitch mounted platform for transporting a dog carrier, coolers, stove or other equipment. Once at the site, however, it may be desirable to have a trailer for use in transporting game carcasses, such as deer or the like over rough terrain and back to the truck. When the game has been delivered to the vehicle, a utility platform is the most efficient means of accomplishing highway transport. However, unless the vehicle has a bed large enough to accommodate both the ATV and trailer, it is unlikely that the trailer can be transported other than by towing. Thus, there is a need for a lightweight, convertible trailer that is suitable for use in association with small specialty vehicles and that can be easily converted on site to form a utility platform for mounting on a vehicle hitch receiver.

It is also desirable to use small trailers as lawn carts in association with lawn tractors and mowers for household garden and yard work. However, conventional lightweight highway trailers are constructed to provide ground clearances that make them unsuitable and unsafe for towing behind such low-clearance vehicles. There is a need for a small, lightweight trailer having structure permitting shifting of the wheel assemblies from a position below a load transporting platform to a position alongside the platform, for lowering the platform and tow bar connection to a position more suitable for use in association with smaller garden vehicles.

Accordingly, there is a need for a lightweight, towable load transporting trailer that can be easily converted for towing behind a small, low ground clearance vehicle, and that can be easily disassembled and reconfigured with stowed wheels to form a utility carrier for mounting on the receiver hitch of a vehicle.

### SUMMARY OF THE INVENTION

The present invention provides a greatly improved convertible trailer and hitch-mountable platform having a platform assembly with removable wheel and tow bar assemblies. The platform is equipped with structure for mounting the disengaged tow bar in a transverse orientation to provide structural support when mounted on the receiver hitch of a vehicle for use as a utility platform. One end of the transversely assembled tow bar is mountable on the vehicle hitch receiver for supporting the utility platform and wheels in a generally horizontal position. The platform also includes structure for stowing the wheel assemblies. Each wheel assembly includes an axle assembly that is positionable to shift the wheels 90° upwardly and rearwardly for lowering the trailer deck for towing use behind a lawn tractor, mower or the like.

In one embodiment of the trailer/platform, mounting structure for the tow bar and stowing structure for the wheel assemblies are positioned on an underside of the platform. The tow bar includes a longitudinal tongue member which is received in a transversely centered tubular longitudinal member for a trailer configuration or a longitudinally centered tubular cross member for a platform configuration. The wheel assemblies include Z-shaped axle brackets including an axle extending from one end of an axle leg and a mounting stub extending from an opposite end. The mounting stubs of the axle brackets are received in the centered cross member for the trailer configuration. For the platform configuration, the mounting stubs are received in transversely mounted tubular wheel sockets mounted fore and aft of the centered cross members. The tongue and mounting stubs may be retained in their respective mounting members by fasteners.

Various objects and advantages of this invention will become apparent from the following description taken in conjunction with the accompanying drawings wherein are set forth, by way of illustration and example, certain embodiments of this invention.

The drawings including FIGS. 1-4 constitute a part of this specification, include exemplary embodiments of the present invention, and illustrate various objects and features thereof.

### BRIEF DESCRIPTION OF THE DRAWINGS

FIG. 1 is a perspective view taken from a top right orientation of a convertible trailer in accordance with the invention with the wheels positioned in an extended orientation to provide maximum ground clearance.

FIG. 2 is a bottom exploded perspective view of the trailer of FIG. 1.

FIG. 3 is a view similar to that shown in FIG. 1, with the wheel assemblies shifted 90° to a retracted orientation to lower the bed for use with a lawn tractor, mower or all-terrain vehicle.

FIG. 4 is a side perspective view of the trailer reconfigured as a utility platform and mounted on the hitch receiver of a truck with the wheels in the retracted orientation.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

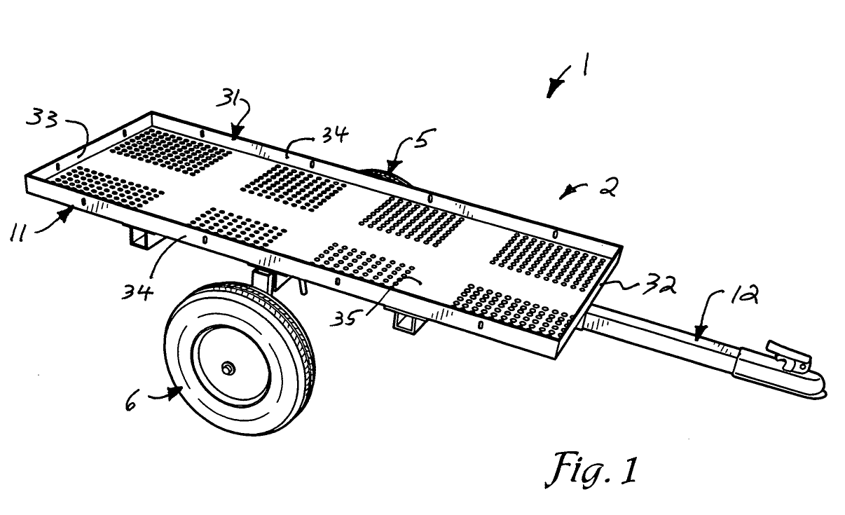

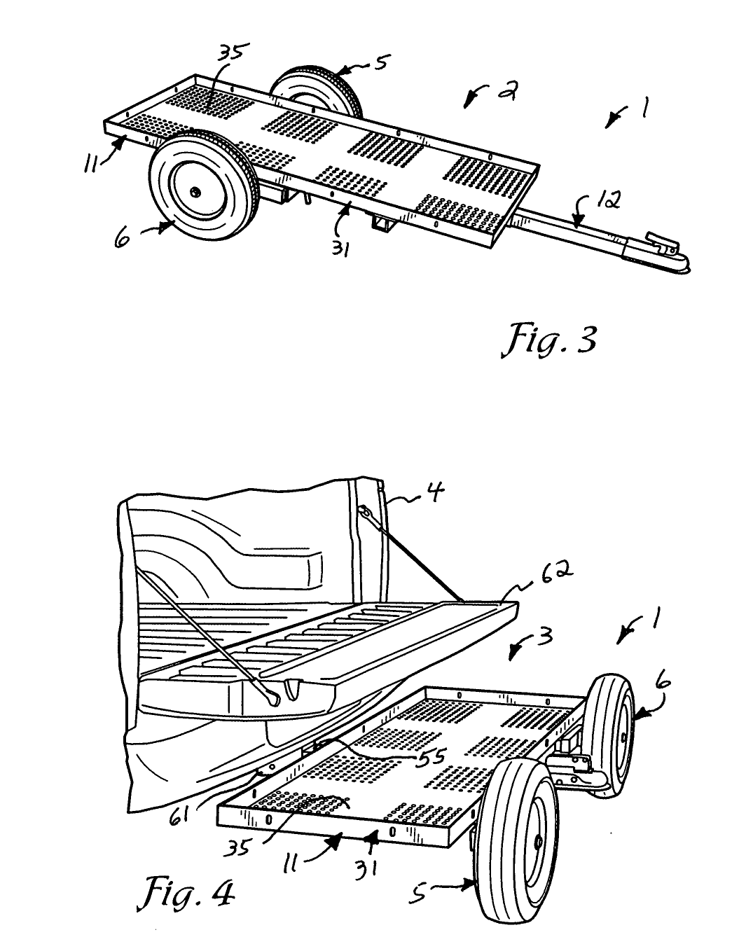

Referring now to the drawing figures, the reference numeral 1 refers to a convertible trailer and hitch mountable platform apparatus in accordance with the invention, which is depicted in FIGS. 1-4. The reference numeral 2 refers to the trailer configuration, which is depicted in FIGS. 1 and 3. The reference numeral 3 refers to the hitch mountable utility platform configuration, which is depicted in FIG. 4 in association with a truck 4.

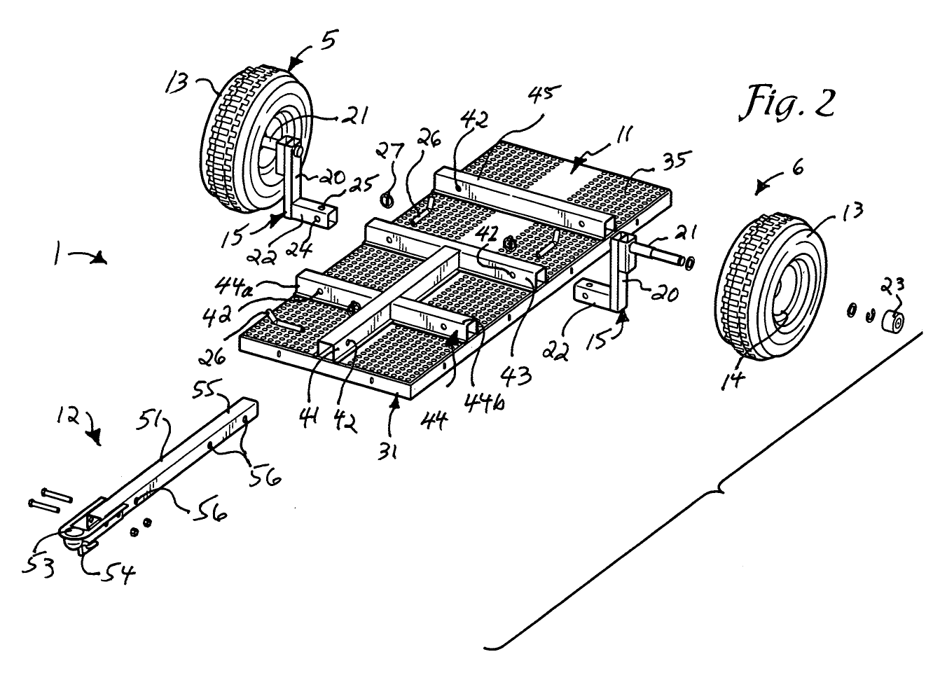

As best shown in FIG. 2, the trailer 2 broadly includes a pair of left and right wheel assemblies 5 and 6 supporting a platform assembly 11 in a generally horizontal elevated relation to the ground or other support surface, and a tow bar assembly 12 demountably coupled with the platform assembly 11.

Referring to FIG. 2, the wheel assemblies 5 and 6 are mirror images, each including a ground engaging tire 13 and a wheel 14 rotatably journaled on an axle assembly or bracket 15 to permit rolling movement of the trailer 2. The wheel assemblies 5 and 6 may alternatively be identical. The axle assembly 15 is approximately Z-shaped and includes an axle leg 20 interconnecting an outwardly extending axle or axle shaft 21 and an inwardly extending mounting stub 22. Each of the wheels 14 is retained in place on the axle 21 by a cap 23 on the outboard end of the axle 21. The wheel assemblies 5 and 6 may be equipped with low speed bushings, high speed tapered roller bearings, or any other suitable construction. The mounting stubs 22 are preferably constructed of square tubular metal stock such as aluminum or steel, and the inboard ends each include two pairs of apertures 24 and 25 for receiving a fastener such as a locking pin 26 with a retainer 27. Alternatively, other fasteners such as bolts and nuts or the like may be employed.

The platform assembly 11 includes a frame 31 having front and rear rails 32 and 33 and a pair of side rails 34, all preferably formed of angle stock (FIG. 1). The frame members are fastened together, as by welding or bolting, to form the generally rectangular shaped frame 31. A generally planar panel, floor, pan, or deck 35 extends between the frame rails to form a bed for supporting a load. The deck 35 may be constructed of sheet metal, metal mesh, molded synthetic resin, wood or any other suitable material or combination thereof and may include a series of spaced slots, perforations or apertures 36 to permit the drainage of liquids and passage of small debris. The deck 35 may also be constructed of a plurality of slats or quadrilateral modules secured to respective ones of the frame rails 32, 33 and 34. The slats or modules may also be secured to each other. Where the frame rails 32, 33 and 34 are fastened by removable elements such as bolts, they may be disengaged and replaced by longer frame rails to expand the length and/or width of the trailer 2 or platform assembly 11.

A tubular longitudinal member or receiver 41 is transversely centered and dependently mounted beneath the forward portion of the deck 35 and secured to the front frame rail 32. The longitudinal member 41 includes a pair of aligned lateral apertures 42 for receiving a fastener 26. A cross member or receiver 43 is longitudinally centered and dependently mounted beneath the deck 35 and secured to the side rails 34. In the trailer configuration 2, the cross member 43 receives the mounting stubs 22 of the wheel assemblies 5 and 6 in such a manner that the legs 20 are substantially vertical to maximize the ground clearance below the platform assembly 11. This is referred to herein as an extended orientation of the wheel assemblies 5 and 6. Forward and aft wheel sockets or receivers 44 and 45 are also dependently mounted on the deck 35 in spaced relation to the cross member 43 and secured to the side members 34. The forward wheel socket 44 is constructed in two shorter pieces, 44a and 44b, which are mounted on either side of the longitudinal member 41. Each of the longitudinal member, wheel sockets and cross member also includes pairs of aligned apertures 42 in spaced relation to the outboard ends for receiving a fastener 26.

The longitudinal member 41, the cross member 43 and the wheel sockets 44 and 45 may be formed of appropriately sized tubular stock, such as square, rectangular or round tubing or of channel or flanged channel stock with welded or otherwise fastened to the platform 11 to close the open sides of the channels. These members need not be of uniform construction. That is to say, the inboard portions may be of solid construction, such as bar, strip or angle stock joined to outboard portions of constructed of hollow stock to form receivers. It is foreseen that the longitudinal member 41 and forward wheel socket 44 and centered cross member 43 may be of unitary construction or joined, for example, by welding. It is also foreseen that the longitudinal member, wheel sockets and cross member may be fastened to the frame 31, and underlie the deck member 35, without fastening connection to the deck 35. A second deck panel 35 may also be fastened to the frame 31 to permit the longitudinal member 41, forward and aft wheel sockets 44 and 45 and centered cross member 43 to be sandwiched between the panels 35. Such construction enables reversal of panel surfaces of the platform 3, which surfaces may be constructed with different surfaces, such as generally planar, corrugated or including raised compartments or dividers. In such embodiments the frame 31 includes apertures positioned for alignment with the ends of the longitudinal member 42 and receivers 43, 44 and 45 to enable reception of a portion of the tow bar assembly 12 and stowing of the wheel assemblies 6. In the illustrated apparatus 1, the receivers 41, 43, 44 and 45 provide additional support for the deck 35.

The tow bar assembly 12 includes a tongue member 51 having a forward end 52 equipped with a coupling 53 for receiving a hitch such as a ball or pin type hitch. The coupling 53 is equipped with a shiftable release latch 54. The tongue member 51 includes an aft or rearward mounting end 55 for connection with the platform assembly 11. The tongue member 51 also includes a series of pairs of laterally aligned apertures 56 for receiving fasteners 26, and it may also include a locking safety chain (not shown) connection to the truck 4.

In one exemplary use, the convertible trailer/platform apparatus 1 in its towable trailer configuration 2 is hitched to a ball hitch 61 of a truck 4 by engaging the truck hitch ball 61 with the coupling 53. The trailer 2 may be used to transport a load, leaving the bed of the truck free for transporting another load, such as, for example, an ATV (not shown). Upon reaching a destination, the latch 54 may be shifted to release the coupling 53, and the steps may be repeated to hitch the trailer 2 to an ATV. The ATV may be used to tow the trailer 2 over rough terrain. When the terrain becomes too rough for passage of the ATV, the trailer 2 may be uncoupled and pulled manually through the brush in the manner of a game sled. The trailer 2 may be loaded with game, wood or any other preferred load for manual pulling back to the ATV. The trailer 2 is then recoupled with the ATV for transporting the load back over rough terrain to the truck 4. The ATV may then be loaded back into the bed of the truck 4 and the trailer 2 disassembled for conversion into a utility platform configuration 3.

As best shown in FIG. 2, the trailer configuration 2 is disassembled by releasing the fastener pins 26 that secure the tongue member 51 to the apertures 42 of the longitudinal member 41 and slidingly disengaging the tongue member 51 from its position telescoped within the longitudinal member 41. The wheel assemblies 5 and 6 are disengaged by releasing the fasteners 26 from the apertures 24 or 25 and sliding the mounting stubs 22 laterally outwardly from their respective telescoped positions within the outboard ends of the cross members 43. The tow bar rear mounting end 55 is next slidingly engaged telescopically through the cross member 43 until the apertures align and the coupling 53 is snugged against the side rail 34 of the platform frame 31 as shown in FIG. 4. This causes the tow bar rear mounting end 55 to extend forwardly, beyond the side of the platform assembly 11. The mounting end 55 of the tongue 51 may be telescopically introduced into either side of the cross member receiver 43, so that the platform assembly 11 is reversible. The wheel assemblies 5 and 6 are next stowed on the platform assembly 11 in side-by-side rearward facing relation by telescopically inserting each mounting stub 22 into a respective one of the forward and aft wheel sockets or receivers 44 and 45 until the wheel stub 24 or 25 and the receiver apertures 42 align. Fasteners 26 are inserted to secure the wheel assemblies 5 and 6 in place. Depending on the positioning of the axle brackets 15, the tires 13 and wheels 14 will substantially project above the platform deck 35 as shown in FIG. 4, or they may substantially depend below the level of the deck 35, in the manner of FIG. 1.

Once the trailer configuration 2 has been converted to the utility platform configuration 3 as described, it may be lifted and the now forwardly-projecting free mounting end 55 of the tongue member 51 telescopically inserted into a hitch receiver 61 of a truck 4 as shown in FIG. 4, or any other suitable vehicle. The mounting end 55 of the tongue 51 is fastened on the hitch receiver by inserting a fastener 26 through the tow bar apertures 56 and into corresponding hitch receiver apertures. If desired, a locking chain may also be engaged between the platform 3 and the truck 4. In its utility platform configuration 3, the platform assembly 11 may be employed as a seat, or used to support or transport a load. The tailgate 62 of the truck 4 may be positioned in a lowered position as shown in FIG. 4, or it may also be positioned in a fully or partially raised position. It also may be freely repositioned without interference with the platform assembly 11.

The trailer/platform apparatus 1 may also be adapted for use as a lawn cart in association with a lawn tractor, mower, golf cart, some ATV's or the like by disassembling the mounting stubs 22 from the centered cross member receiver 43 by releasing the fastener pins 26 and slidingly disengaging the mounting stubs 22 as shown in FIG. 2. The axle brackets 15 may be then be rotated 90° rearwardly and the mounting stubs 22 reintroduced into the respective outboard ends of the centered cross member receiver 43 until the bracket apertures 25 align with the cross member apertures 42. The wheel assemblies 5 and 6 are held in place by reintroducing the fasteners 26 through the aligned apertures 25 and 42. Because of the generally Z-configuration of the axle brackets 15, rotation of the mounting stubs 22 a distance of 90° rearwardly serves to position the axles 21 approximately transverse to a respective frame side rail 34, lowering the deck 35 with respect to the wheels 14 and tires 13. This is referred to herein as a retracted orientation of the wheel assemblies 5 and 6. The retracted orientation serves to lower the tow bar assembly 12 with respect to the ground or other support surface, enabling engagement of the coupling 53 with the lower hitch of a garden vehicle or other vehicle.

It is to be understood that while certain forms of the present invention have been illustrated and described herein, it is not to be limited to the specific forms or arrangement of parts described and shown.

What is claimed and desired to be secured by Letters Patent is:

1. A convertible trailer and hitch mountable platform apparatus comprising:
(a) a platform having opposite sides and opposite ends, said platform having a longitudinally extending tow bar receiver;
(b) an elongated tow bar having a hitch coupling at one end and having an opposite mounting end removably received in said tow bar receiver in a trailer configuration of said apparatus;
(c) a pair of wheel assemblies removably connected to said platform on opposite sides thereof in said trailer configuration;
(d) said platform including a pair of wheel sockets positioned to removably receive said pair of wheel assemblies on a same side of said platform in a platform configuration of said apparatus; and
(e) said platform including a transverse tow bar receiver to receive said tow bar across said platform with said mounting end extending past a side of said platform in said platform configuration to thereby enable said mounting end to be received in a hitch receiver of a vehicle.

2. An apparatus as set forth in claim 1 wherein:
(a) said wheel assemblies are connected to said platform in said trailer configuration by reception in said transverse tow bar receiver on opposite sides of said platform.

3. An apparatus as set forth in claim 1 wherein:
(a) said wheel assemblies are configured in such a manner and cooperate with said platform in such a manner as to enable said wheel assemblies to be selectively connected to said platform in an extended orientation for relatively high ground clearance or in a retracted orientation for relatively low hitch height of said hitch coupling in said trailer configuration.

4. An apparatus as set forth in claim 1 wherein:
(a) one of said pair of wheel sockets is positioned in front of said transverse tow bar receiver and the other of said wheel sockets is positioned behind said transverse tow bar receiver.

5. An apparatus as set forth in claim 1 wherein:
(a) each of said wheel sockets extends from one side of said platform to the opposite side thereof to enable said pair wheel assemblies to be received therein on one side of said platform or the other side thereof in said platform configuration.

6. An apparatus as set forth in claim 1 wherein said platform includes:
(a) a frame formed by a plurality of frame members; and
(b) a deck secured to said frame members for supporting a load in said trailer or platform configurations of said apparatus.

7. An apparatus as set forth in claim 1 wherein:
(a) each of said wheel assemblies includes a mounting stub having a non-round cross section;
(b) said wheel sockets are tubular and have non-round cross sections sized to receive the mounting stubs of said wheel assemblies;
(c) said tow bar has a non-round cross section; and
(d) said transverse tow bar receiver is tubular and has a non-round cross section sized to receive said tow bar therethrough.

8. A convertible trailer and hitch mountable platform apparatus comprising:
(a) a platform having opposite sides and opposite ends, said platform having a longitudinally extending tow bar receiver centered between said opposite sides and a transversely extending wheel receiver positioned between said opposite ends;
(b) an elongated tow bar having a hitch coupling at one end and having an opposite mounting end removably received in said tow bar receiver in a trailer configuration of said apparatus;
(c) a pair of wheel assemblies removably received in said wheel receiver on opposite sides of said platform in said trailer configuration;
(d) said platform including a pair of wheel sockets positioned to removably receive said pair of wheel assemblies on a same side of said platform in a platform configuration of said apparatus; and
(e) said wheel receiver removably receiving said tow bar therethrough with said mounting end extending past a side of said platform in said platform configuration to thereby enable said mounting end to be received in a hitch receiver of a vehicle.

9. An apparatus as set forth in claim 8 wherein:
(a) each of said wheel assemblies includes a mounting stub having a square cross section;
(b) said wheel receiver is tubular and has a square cross section;
(c) each of said wheel assemblies has said mounting stub received in said wheel receiver in an extended orientation to position said platform at a relatively high ground clearance in said trailer configuration; and
(d) each of said wheel assemblies has said mounting stub received in said wheel receiver in a retracted orientation to orient said platform in a substantially level condition with said hitch coupling positioned at a relatively low hitch height in said trailer configuration.

10. An apparatus as set forth in claim 8 wherein said wheel receiver has a square cross section and wherein each wheel assembly includes:
(a) a Z-shaped wheel bracket including an axle leg with a mounting stub extending perpendicularly from one end and an axle shaft extending perpendicularly from an opposite end, said mounting stub being received in said wheel receiver in said trailer configuration and in one of said wheel sockets in said platform configuration;
(b) a ground engaging wheel rotatably mounted on said axle shaft;
(c) said mounting stub being received in said wheel receiver in an extended orientation with said axle leg substantially vertical to position said platform at a relatively high ground clearance in said trailer configuration; and
(d) said mounting stub being received in said wheel receiver in a retracted orientation with said axle leg substantially horizontal to orient said platform in a substantially level condition with said hitch coupling positioned at a relatively low hitch height in said trailer configuration.

11. An apparatus as set forth in claim 8 wherein:
(a) said wheel receiver is longitudinally centered between said opposite ends of said platform.

12. An apparatus as set forth in claim 8 wherein:
(a) said wheel receiver is longitudinally centered between said opposite ends of said platform; and
(b) one of said pair of wheel sockets is positioned in front of said wheel receiver and the other of said wheel sockets is positioned behind said wheel receiver.

13. An apparatus as set forth in claim 8 wherein:
(a) each of said wheel sockets extends from one side of said platform to the opposite side thereof to enable said pair wheel assemblies to be received therein on one side of said platform or the other side thereof in said platform configuration.

14. An apparatus as set forth in claim 8 wherein said platform includes:
(a) a rectangular frame formed by a plurality of frame members; and
(b) a deck secured to said frame members for supporting a load in said trailer or platform configurations of said apparatus.

15. A convertible trailer and hitch mountable platform apparatus comprising:
(a) a platform having opposite sides and opposite ends, said platform having a longitudinally extending tow bar receiver centered between said opposite sides and wheel receiver positioned between said opposite ends and extending transversely between said opposite sides, each of said tow bar receiver and said wheel receiver having a square tubular cross section;
(b) an elongated tow bar having a hitch coupling at one end and having an opposite mounting end removably received in said tow bar receiver in a trailer configuration of said apparatus;
(c) a pair of wheel assemblies removably received in said wheel receiver on opposite sides of said platform in said trailer configuration, each wheel assembly including:
(1) a Z-shaped wheel bracket including an axle leg with a mounting stub extending perpendicularly from one end and an axle shaft extending perpendicularly from an opposite end, said mounting stub being received in said wheel receiver in said trailer configuration;
(2) a ground engaging wheel rotatably mounted on said axle shaft;
(3) said mounting stub being received in said wheel receiver in an extended orientation with said axle leg substantially vertical to position said platform at a relatively high ground clearance in said trailer configuration; and
(4) said mounting stub being received in said wheel receiver in a retracted orientation with said axle leg substantially horizontal to orient said platform in a substantially level condition with said hitch coupling positioned at a relatively low hitch height in said trailer configuration;
(d) said platform including a pair of wheel sockets positioned to removably receive said pair of wheel assemblies on a same side of said platform in a platform configuration of said apparatus, each of said wheel sockets having a square tubular cross section; and
(e) said wheel receiver removably receiving said tow bar therethrough with said mounting end extending past a side of said platform in said platform configuration to thereby enable said mounting end to be received in a hitch receiver of a vehicle.

16. An apparatus as set forth in claim 15 wherein:
(a) each of said wheel sockets extends from one side of said platform to the opposite side thereof to enable said pair wheel assemblies to be received therein on one side of said platform or the other side thereof in said platform configuration.

17. An apparatus as set forth in claim 15 wherein said platform includes:
(a) a rectangular frame formed by a plurality of frame members; and
(b) a deck secured to said frame members for supporting a load in said trailer or platform configurations of said apparatus.

18. An apparatus as set forth in claim 15 wherein:
(a) said wheel receiver is longitudinally centered between said opposite ends of said platform.

19. An apparatus as set forth in claim 15 wherein:
(a) said wheel receiver is longitudinally centered between said opposite ends of said platform; and
(b) one of said pair of wheel sockets is positioned in front of said wheel receiver and the other of said wheel sockets is positioned behind said wheel receiver.

20. An apparatus as set forth in claim 15 wherein:
(a) said hitch coupling is adapted from connection to a conventional ball trailer hitch.
